(19) United States
(12) Patent Application Publication
(10) Pub. No.: US 2014/0324479 A1
(43) Pub. Date: Oct. 30, 2014

(54) Consent Repository Providing Automated Patient Authorization Decisions Affecting the Release of Health Information

(71) Applicant: Jericho Systems Corporation, Dallas, TX (US)

(72) Inventors: Michael Dufel, Boulder, CO (US); David Staggs, Austin, TX (US)

(21) Appl. No.: 14/329,964

(22) Filed: Jul. 13, 2014

Related U.S. Application Data
(63) Continuation of application No. 14/327,783, filed on Jul. 10, 2014.
(60) Provisional application No. 61/918,050, filed on Dec. 19, 2013.

(51) Int. Cl. G06F 19/00

(52) U.S. Cl. CPC G06F 19/322
USPC 705/3

(57) ABSTRACT

A method and system for controlling the release of health information about an individual. A patient consent repository provides authorization to release all or part of requested health information based, in part, on attributes and sensitivity labels passed in the request for consent.

### PRIORITY

This application is a continuation of U.S. patent application Ser. No. 14/327,783, filed Jul. 10, 2014, entitled “Automated Patient Consent and Reduced Information Leakage Using Patient Consent Directives” which claims the benefit of priority to U.S. Provisional Patent Application 61/918,050, filed Dec. 19, 2013, entitled “Automated Patient Consent and Reduced Information Leakage Using Patient Consent Directives.”

This invention was made with Government support under USAMRMC, W81XWH-13-C-0116. The Government has certain rights in the invention.

Access to protected health information (PHI) and clinical data has been improved through the local use of electronic health records (EHR). Coordinated efforts of standards development organizations (SDO) has ensured EHR can be stored, retrieved, and comprehended using unrelated systems throughout a health care provider organization's information technology (IT) network. Consequently, unrelated organizations have begun to share patients' EHR across external networks, e.g. the Internet, with other organizations in order to reduce duplicative medical tests, perform longitudinal medical studies, support the use of prescriptions sent electronically (ePrescription), provide efficient medical care during medical emergencies, and simplify reporting, e.g., to request government medical benefits.

The decision to electronically release clinical information to an unrelated requesting organization can be made automatically using computer-enforced policy. A requesting organization can be any organized group of individuals or a single individual. Examples include as hospitals, government or private payors, insurers, service agencies, public health agencies or other business partners. Individuals that may request information include, for example, consultants, clinicians in solo practice, and other individuals. The ability for patients to specify the circumstances and type of PHI they agree should be shared by their health care provider organization is not widely available. Additionally, patients typically have no easy way of learning that their PHI has been shared.

One approach for automating the PHI release decision is described in the Health Information Technology Standards Panel (HITSP) transaction package 20 (TP20). In TP20, requests from external organizations are made to an access control system (ACS). Access to PHI through the ACS can be, for example, under the control of a policy enforcement point (PEP). In this model, the PEP sends the request context to a policy decision point (PDP) for the policy-driven release decision. The PDP makes the release decision based on attributes passed to the PDP, information retrievable by the PDP, and the applicable policy. Policy can, for example, represent organizational requirements, legal obligations, and patient preferences.

Separation of the PEP from the PDP permits flexibility in the deployment and choice of computerized policy-driven release decisions. An example policy language, developed by the Organization for the Advancement of Structured Information (OASIS) SDO, is called eXensible Access Control Markup Language (XACML), although other languages and architectures, for example, the Basic Patient Privacy Consents (BPPC) profile, exist.

Example specifications for the exchange of health care information include eHealth Exchange, once known as the Nationwide Health Information Network (NwHIN) Exchange, NwHIN Direct (Direct), and European Patients Smart Open Services (epSOS). Example protocols that can be used to exchange information include SOAP (originally defined as Simple Object Access Protocol), Representational State Transfer (REST), or Simple Mail Transfer Protocol (SMTP). Information exchanges can be used to exchange information within a single multi-region health care provider, between multiple health care providers, e.g. a health information exchange (HIE), or between diverse stakeholders that support health care delivery, as examples.

Policies used in computerized policy-driven release decisions are typically evaluated against attribute information delivered in the request context and additional information, which may be retrieved from data stores. Computable policies can be used to support different access control models such as attribute-based access control (ABAC), role-based access control (RBAC), context-based access control (CBAC), and rule-based access control (RuBAC), as examples.

A patient's consent to release information can be encoded in a computerized policy that can be evaluated during the request for information from an outside organization by the document custodian. A document custodian is an organization, system, or individual entrusted with a document. One approach would require the patient to “opt-in,” i.e. consent to the release of all PHI at the discretion of the document custodian, or “opt-out,” i.e. refuse all release of PHI. In contrast to this “coarse” approach, “fine grain” authorization also provides “opt-in with restrictions” and “opt-out with exceptions.” Opt-in with restrictions would generally allow information to be shared but the patient could specify that only specific data may be included under certain conditions. Opt-out with exceptions would generally disallow the sharing of PHI outside the health care provider organization but provides for sharing of PHI under certain conditions. Fine grain authorization provides greater expression of consent, such as an agreement to the sharing of some information, e.g. drug allergies, but restricting the release of information that a patient feels should be kept private, e.g. psychotherapy notes.

In many deployment architectures, patient consent is stored in one or more data stores, such as a database or, more specifically, a Cross Enterprise Document Sharing (XDS.b) data store. Vendors that provide electronic medical record (EMR) or EHR systems may embed the patient consent data store within a proprietary system. Large organizations may use a standards-based patient consent data store that is accessible within the provider organization using standard profiles. Deployment architectures are frequently based on workflow scenarios developed by consensus organizations, such as Integrating the Healthcare Enterprise (IHE), National Committee on Vital and Health Statistics (NCVHS), American Health Information Community (AHIC), HL7, OASIS, and various government efforts, such as pilots sponsored by the Office of the National Coordinator for Health Information Technology (ONC).

An example standard representation of patient consent from Health Level Seven (HL7) that encodes consent options in a clinical document compatible with the HL7 Clinical Design Architecture (CDA) is called the privacy consent directive. A more general term for the encoding of a patient's sharing preferences is called a patient consent directive (PCD). A PCD describes the conditions under which certain information about the patient can be shared to certain organizations or individuals for particular purposes.

### DESCRIPTION OF THE DRAWINGS

FIG. 1 shows a high-level example of the flow of information in a request for information, including the dynamic creation of a PCD.

FIG. 2 shows a high-level example of the flow of information in a request for information, including the use of data segmentation labels.

FIG. 3 shows a high-level example of the flow of information in a request for information, including access to audit information viewed from a portal.

FIG. 4 shows representations of example Graphical User Interfaces (GUIs) which may be used in a portal application. Specifically, FIG. 4A depicts a web page allowing, for example, the user to create and edit a PCD and review requests for their information. FIG. 4B depicts a web page popup allowing the user to select their consent posture. FIG. 4C depicts a web page popup allowing the user to select sensitive topics for use in their PCD.

FIG. 5 shows a representation of computer hardware that could be used to provide the functionality described in the specification.

FIG. 6 shows a representation of an example deployment of software and hardware components providing the functionality described in the specification.

FIG. 7 shows a representation of an example policy evaluation environment supporting the decision to release information as described in the specification.

### EXEMPLARY DESCRIPTION OF THE INVENTION

The invention comprises systems involved in the automated release of information, which could include personal information such as PHI, EHR, or other health care related information. One example is the use of a policy-driven automated release system. The automated release system receives requests for information and determines if that information should be released based on computable policy. One example of a computable policy language is XACML, but others are possible. The policy is evaluated at the time of each request to determine if the circumstances of the request permit the release of the requested information.

The release decision typically involves parsing information passed with the request, combining information relevant to the request with information about the requested information, and comparing the combined information to the rules encoded in the appropriate computable policy. The computable policy may enforce various requirements for the release of the requested information such as: organizational requirements determined by the document custodian, jurisdictional requirements determined by federal, state, or local law, and directives of the subject of the information, for example, PCDs. Characteristics of the release context, for example attributes and their corresponding values, can be further used to support different access control models in the document custodian's authentication and authorization architecture such as ABAC, RBAC, CBAC, and RuBAC, as examples.

PCDs express the circumstances under which the subject described in the requested information, for example, an EHR, would agree to the release of the information. In fine grain PCDs circumstances may include the purpose for which the information may be used. A list of the types of purposes of use (POU) can be found, for example, in ASTM (formerly an initialization of the American Society for Testing and Materials) health care standard E1986-09 Standard Guide for Information Access Privileges to Health Information or the OASIS eXtensible Security and Privacy Authentication (XSPA) Profile of Security Assertion Markup Language (SAML) for Healthcare Version 1.0, which is included as Table 1. Fine grain PCDs may also qualify the release of requested information based on the requesting organization name or location, the type of information being requested, or the name or role of the requestor, as examples. These attributes are typically described in standards, such as the OASIS eXtensible Security and Privacy Authentication (XSPA) profiles or the International Organization for Standardization (ISO) 10183—Part 3 “Information technology—Open Systems Interconnection—Security frameworks for open systems: Access control framework.”

TABLE 1
POU Attributes from XSPA Profile of SAML for Healthcare

| Description | Allowed Value |
|---|---|
| Healthcare Treatment | TREATMENT |
| Payment | PAYMENT |
| Operations | OPERATIONS |
| Emergency Treatment | EMERGENCY |
| System Administration | SYSADMIN |
| Research | RESEARCH |
| Marketing | MARKETING |
| Request of the Individual | REQUEST |
| Public Health | PUBLICHEALTH |

Additional information on consent management is described in HITSP Transaction Package thirty (TP30). TP30 describes means to convey personal privacy policies for integration into the document custodian's computable policy. Use of the HITSP TP20/TP30 model may require the review and acceptance of the PCD prior to placing the PCD into the document custodian's computable policy data store. Requiring a human review of a consenter's policy limits the speed in which a new PCD can be enforced.

An ONC data segmentation for privacy (DS4P) working group has suggested the use of a PCD repository outside any one organization in “Use Case Development and Functional Requirements for Interoperability.” However, several obstacles surrounding the use of an external PCD repository remain. For example, circumstances describing the appropriate release of sensitive information from one provider should not be included in a PCD sent to an unrelated provider. For example, participation in a substance abuse treatment clinic should not be revealed through the exchange a PCD requested by another health care provider.

Some information leakage might be possible if the external PCD repository is used by a health care consumer to store directives for the appropriate release of information from more than one of their health care providers. However, maintaining separate directives over the release of information, for example, a different PCD for each health care provider, can be confusing and lead to undesirable effects. A composite release policy maintained at the PCD repository is more efficient and easier to maintain. For example, a composite release policy can easily express the directive to not release any information from any of a patient's providers when the POU is for marketing.

Information leakage from an external PCD repository can be controlled through the dynamic generation of a PCD specific to the document custodian (the PCD requestor) and the circumstances of the request (for example the organization requesting the information from the document custodian). For example, the PCD specific to a request could be dynamically generated from the composite policy using the IHE “On-Demand Documents Trial Supplement” specification.

The dynamic or non-dynamic PCD can be used by the document custodian to compute the release decision. One approach is for a consenter's agent to pass computable PCD policy to the document custodian for use with, for example, organizational and jurisdictional policies considered by the document custodian's ACS PDP. However, a document custodian's PDP policy engine can experience computational failures when using foreign policy from a foreign PCD repository, for example, because of differences in vocabulary, semantic non-interoperability, and use of unavailable policy language constructs. A dynamically generated PCD can pass local, retrieved, and/or parametric information to enable an ACS PDP to compute an authorization decision. Alternatively, a dynamically generated PCD can contain an authorization decision determined by a PDP at the PCD repository based on, in part, the information sent with the PCD request and the consenter's computable policy. Returning the consenter's authorization decision within the PCD, i.e., “allow” or “deny,” allows ingestion by the document custodian's ACS PDP more easily and safely than using the consenter's computable policy locally, for example, in a document custodian PDP policy engine.

Returning the consenter's authorization decision within the PCD makes the health care consumer's sharing directive useful in additional architectures. For example, the PCD can be used in architectures using an access control list (ACL). The consenter's authorization decision can also be used in hard-coded approaches. Other rules-based and table-based approaches are possible, including business rule management system (BRMS), for example. PCDs can be used by systems and languages such as Drools, Jess, Prolog, OpenL, DTRules, W3C's Web Ontology Language (OWL), and Common Object Request Broker Architecture (CORBA), as non-limiting examples.

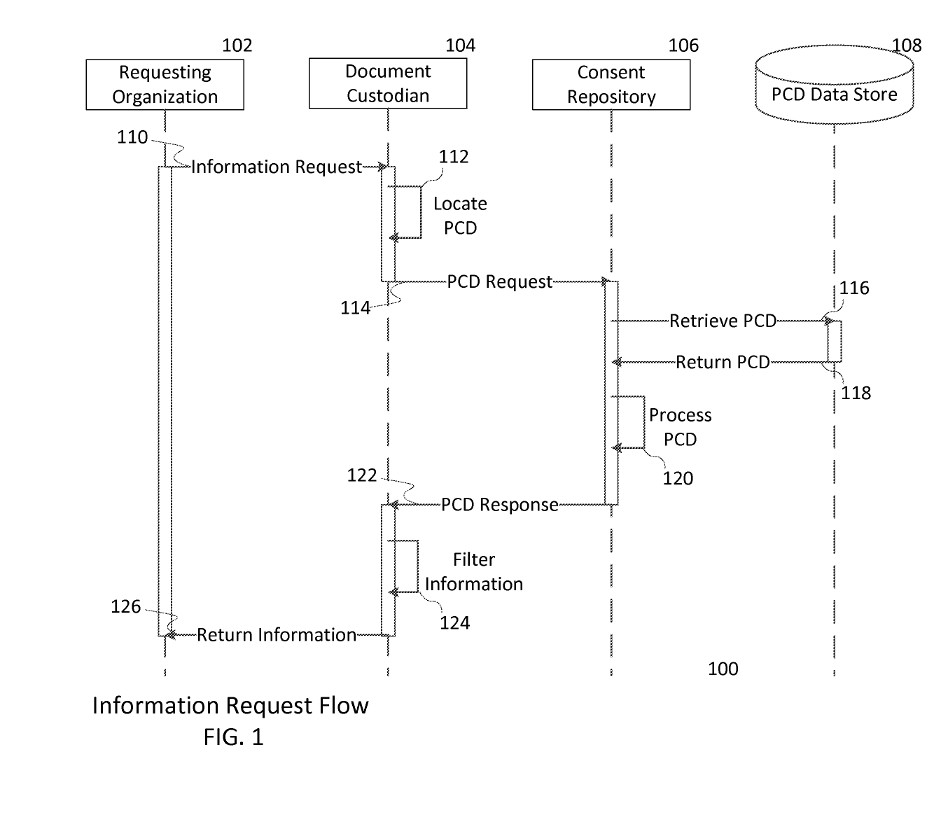

An example of the use of a PCD is shown in FIG. 1. A requesting organization 102 can be configured, for example using the SOAP protocol, to make an information request 110. An organization that may possess the desired information, for example document custodian 104, receives request 110 and identifies one or more relevant PCD 112. A request is made to at least one Consent Repository 106 at 114. Consent Repository 106 optionally retrieves information from local or remote data stores, which could be at least one PCD Data Store 108 at 116. Information, which could represent a consenter's policy, composite PCD policy, policy attributes, or equivalent, is returned from PCD data store 108 to consent repository 106 at 118. A repository is a storage location for the safekeeping of information, for example on computer-accessible media. The information can be processed by or for consent repository 106 at 120 to generate a PCD appropriate to the request made by requesting organization 102 to document custodian 104. The processed PCD may include computable policy and/or an authorization response. The PCD returned to document custodian 104 at 122 is used, in combination with local information and/or policy, to make the information release decision. Information can be optionally filtered by document custodian 104 at 124, possibly based on information returned in the PCD at 122. Filtering is the process of examining information against certain qualifying criteria and possibly removing or encrypting portions of the information before releasing it to a requestor. Document custodian 104 then optionally returns releasable information to requesting organization 102 at 126.

A document custodian might receive a request for information that is found in a partially shareable document. For example, a request for information about a particular patient might result in an EHR or summary document that contains a section that includes information that is not releasable outside the organization. In such cases, partial information could be released to the requestor. One approach is to return the entire document with unreleasable portions removed (redacted) with or without indication of the removed information. Alternatively, unreleasable information can be made unreadable in the absence of a cryptographic key. The cryptographic key that would make the filtered information readable could be then made available under certain circumstances.

Protection of content that is sensitive, i.e., might require redaction, encryption, or other treatment, is a complicated problem. Sensitive information is sometimes identified by indicators or labels embedded with the information, a process typically referred to as a type of data segmentation. The segmenting or labeling of information can be done dynamically or as the information is entered, e.g. entering data into an electronic medical records (EMR) application. One example of the segmenting or labeling of health related information is the HL7 Health Classification System (HCS). Examples of vocabulary terms used to identify information content are, for example, HL7 Confidentiality Code and/or HL7 Sensitivity and Privacy Policy Codes.

Health care consumers may want to express directives over the release of sensitive information within a collection of information, for example a document, EHR, or health summary. For example, a consenter may want to allow the sharing of health care related information except for information about psychotherapy. This circumstance can have legal consequences for document custodians which may have legal obligations to receive consent before releasing certain sensitive information. Commercial products, such as the Patient Privacy Portal™ from Jericho Systems Corporation, allow users to specify sensitive information that should be withheld under specific circumstances.

The identification of information categories considered sensitive by the consenter can result in information leakage. For example, if a PCD includes all categories that the consenter considers sensitive, the organization receiving the PCD may use that information to draw inferences about the consenter's health. For example, a consenter may indicate that information related to human immunodeficiency virus, denoted in HL7 confidentiality code as HIV, should not be released. This may result in the requestor of the PCD inferring that the consenter has a diagnosis of HIV even if none of his or her records so indicate.

Information leakage can be reduced by including codes specifying sensitive information only when the identical code is passed with the request for the PCD. In one example, the document custodian must dynamically label information in a requested document or scan for labels in the requested document if it contains labeled information. The labels found in the requested document are provided to the PCD repository, which also receives information about the requesting organization, document custodian and other information, as described above. The label information can thus be limited to labels related to the requested information dynamically generated PCD, instead of all labels identified by the consenter known to the PCD repository. The resulting PCD can be considered by the document custodian as it applies the organization policy to the release decision.

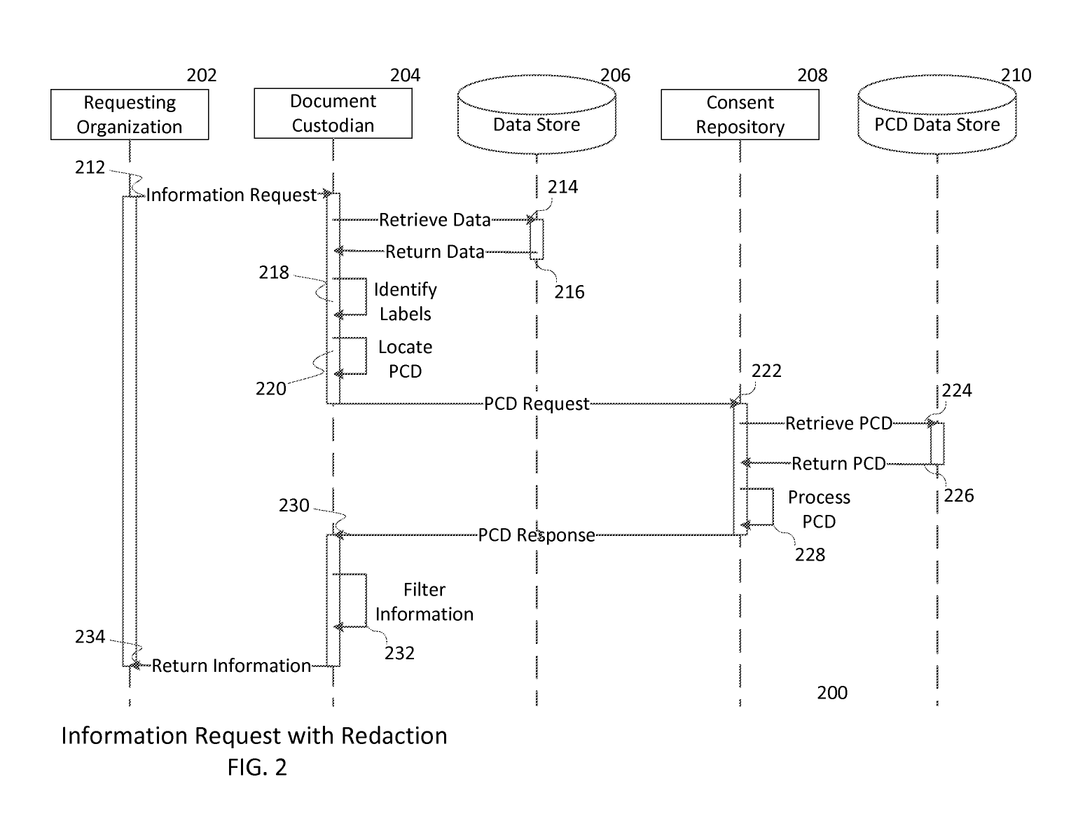

An example of the use of a PCD for expressing one or more directives involving redaction and/or encryption is shown in FIG. 2. A requesting organization 202 can be configured, for example using the SOAP protocol, to make an information request 212. An organization that may possess the desired information, for example document custodian 204, receives request 212. Document custodian 204 identifies relevant information, which could include one or more documents, from data store 206, for example. A data store is any computer-accessible collection of data, for example a disk drive, database, or table. A request is made for the data, for example retrieving data from data store 206 at 214. Data is returned to document custodian 204 at 216, however other approaches such as a pre-fetch are possible. Document custodian 204, or equivalent, identifies data labels affecting release, such as confidentiality codes or privacy and security labels, at 218. Identification of codes in the requested information may require dynamic data labeling if the requested information is not labeled data. Document custodian 204 identifies one or more relevant PCD 220, and retrieves the relevant PCD either locally or using a request at 222. Consent repository 208 receives request 222 and optionally retrieves information from local or remote data stores, which could be at least one PCD data store 210, at 224. Information, which could represent a consenter's policy, composite PCD policy, policy attributes, or equivalent, is returned to consent repository 208 at 226. The resulting information can be processed by consent repository 208 at 228 to generate a PCD appropriate to the request made by the requesting organization 202 to document custodian 204. The processing of a PCD at 228 can use labels identified at 218 to limit the labels returned at 230 to those labels identified as sensitive by the consenter. That is, only labels already known to document custodian 204 will be included in the returned PCD. The processed PCD may also include computable policy and/or an authorization response. The PCD returned to document custodian 204 at 230 is used, in combination with local information and/or policy, to make the information release decision. A release decision is the determination as to whether all or some of the information will be released to a requestor. Information can be optionally filtered by document custodian 204 at 232, possibly based on information returned in the PCD at 230. The filtering of the requested information at 232 may use data segmentation to remove or encrypt unreleasable information. Example mechanisms supporting data segmentation, data redaction, and/or data filtering at 232 include a Security Labeling Service (SLS), as described in HL7 HCS, or a data redaction service. An SLS identifies categories of information using, for example, tags or labels, for subsequent processing. Document custodian 204 then optionally returns releasable information to requesting organization 202 at 234.

As shown in FIG. 2, PCD information leakage triggered by document custodian 204 because of request 212 can be reduced at 228 by comparing information known about the request and the document custodian 204 to the content of the information available to consent repository 208. The consenter's complete directive, which may be stored, for example, at PCD data store 210, can be reduced in scope to the current request. For example, if the request was made with a POU of emergency, the details of the consenter's directive for other POU, for example marketing and research, will not necessarily be sent to document custodian 204 for use in determining the release decision at 232. Another example would be a consenter's directive that is specific to document custodian 204 and/or requesting organization 202. For example, if a subset of the composite PCD specifies that the document custodian, i.e. “General Hospital,” must not release any information to “Marketing Affiliates of Austin,” then the rest of the composite PCD does not necessarily need to be sent to document custodian 204, i.e. “General Hospital” if the original request is made by “Marketing Affiliates of Austin.” This approach reduces unnecessary release of information about the consenter's sharing choices encoded in the composite PCD to document custodians requesting a PCD for a specific information request. One approach to reducing information leakage is to determine, based on the information known about request 212, requesting organization 202, document custodian 204, and the requested information, an authorization decision (allow or deny) based on the relevant aspects of the PCD.

Information leakage from the composite PCD or equivalent can also be reduced in the case of labeled data. For example, consider an information request 212 from requesting organization 202 specifying a specific document in document custodian's 204 data store 206. Document custodian 204 can identify all data segments in the documents being requested, either by inspection or by dynamically labeling information based on content. The data segments identified in the document being requested are passed by document custodian 204 to consent repository 206, for example at 222. The consenter's directives, or equivalent, specific to the circumstances of request 212 and actors 202 and 204, may contain directives specific to data segments. For example, document custodian “General Hospital” must not release substance abuse related information (ETH) or psychotherapy (PSY) in documents requested by requesting organization “Dermatology Affiliates of Austin.” If the requesting organization 202 “Dermatology Affiliates of Austin” requests a specific document from document custodian 204 “General Hospital” that contains data labeled with substance abuse related information (ETH) that label will be made available with the PCD request 222. In our example, the relevant portion of the composite PCD would disapprove of releasing ETH or PSY data in any document released. Information leakage is reduced by returning the ETH label (known to document custodian 204 because it is in the requested document) but not necessarily returning the PSY label (which may not be known at this time because it is not in the request). One approach to reducing information leakage is to determine, based on the information known about request 212, requesting organization 202, document custodian 204, and the requested information, an authorization decision, i.e., allow or deny, based on the relevant aspects of the PCD. In the case of data segmentation, if the consenter's authorization decision was “allow” the response would be returned with any relevant data labels that should be redacted or filtered from the document. Reducing information leakage in this way is not stated in the DS4P (DS4P) “Use Case Development and Functional Requirements for Interoperability” document.

PCD information can be stored in a single location or in redundant locations or can be stored as PCD information in multiple data stores and assembled dynamically. Access to PCD information can be made through, for example, the IHE Cross-Enterprise Document Sharing (XDS) Integration Profile. Retrieval of PCD information may use both a document registry and a document repository. Alternatively, PCD information can be requested directly from a data store, which could be a data base or a database management system (DBMS) such as MySQL, PostgreSQL, or dBase, as examples.

Once the directive represented in the PCD is considered along with other policy, such as organizational and jurisdictional policy, the decision to release the requested information can be automatically computed. The release decision can be recorded and made available to other actors. For example, the release decision can be sent to an audit system that collects records from any document custodian that uses the consent repository. Many approaches are possible, for example use of the IHE Audit Trail and Node Authentication (ATNA) integration profile. Information on the information request and actors can be stored and made available for retrieval and review at some other time, for example using a portal, which may also be used for creating and editing PCDs. Providing transparency to the exchange of information in this way is not found in the DS4P (DS4P) “Use Case Development and Functional Requirements for Interoperability” document. In one example, the individual who is the subject of the information request would see the release decision made by any document custodian in possession of his or her records. Access to the release decision would allow the individual to adjust his or her PCD, detect and report fraud such as medical identity theft, or detect and report any miscorrelation of their identity with another's, that could lead to the comingling of medical records.

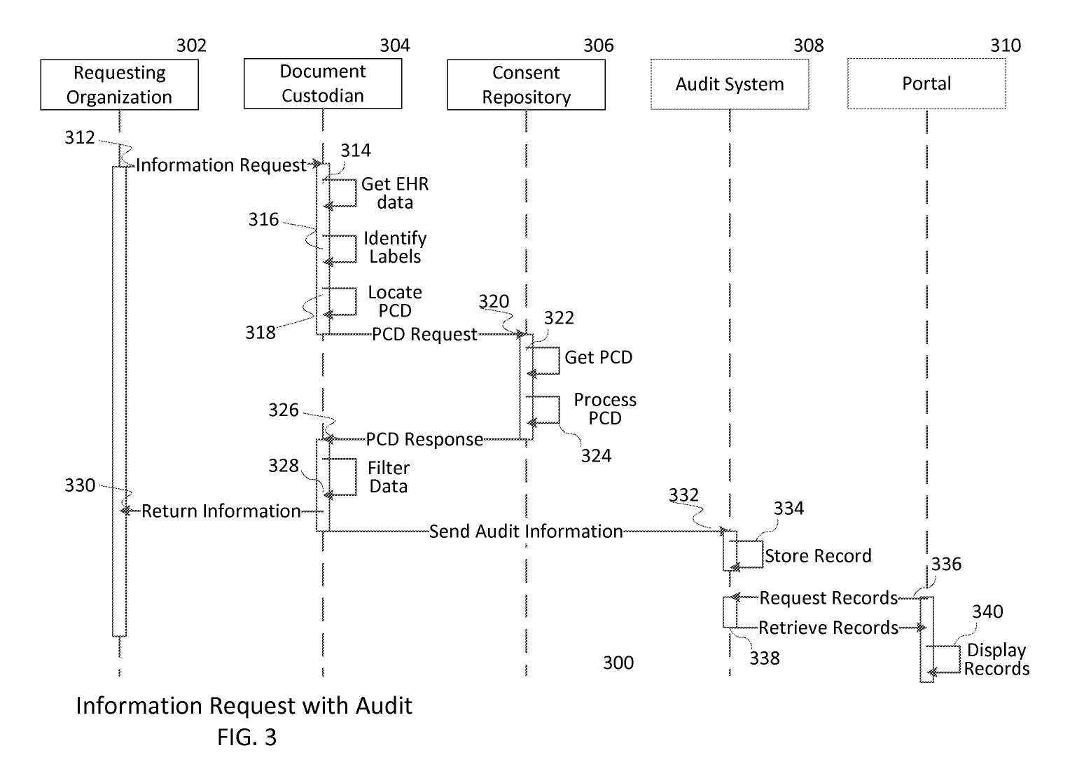

As shown in FIG. 3, requesting organization 302 sends information request 312 over some protocol, such as SOAP, REST, or SMTP. Document custodian 304, receives the request and retrieves the relevant information at 314. If data segmentation is supported, labels in the requested information may be identified at 316. Document custodian 304 identifies one or more relevant PCD at 318 and retrieves the relevant PCD information either locally or using a request at 322. The PCD information may be processed to reduce information flow at 324, then sent to document custodian 304 in response 326. The requested information made be processed to reduce or augment information at 328, then sent to the requesting organization 302 in response 330. Document custodian 304 may then send the release decision, with information on the request, to audit system 308, where the information is optionally stored. Additional audit information may be sent at any time and at any step in the process described. At some later time, individuals can request from audit system 308 audit information detailing the release of their information from any of their document custodians participating in the described process. The request for audit information may be made, for example, from portal 310 by sending a request 336 to audit system 308, which returns the appropriate information at 338. At any time subsequent to this, the portal user can review details of information requests and corresponding release decisions at 340 using portal 310.

A portal is used herein to signify a capability that allows an individual to, for example, create, review, edit, store, or revoke a PCD. The portal may provide additional information, for example, by displaying requests for the user's PHI from a document custodian or the existence of educational or research opportunities that the user might be interested in. The portal described herein may be a web portal, which is frequently a collection of web pages served by one or more application servers or one or more applications or a combination of both. The portal may be presented to the user in various ways, for example through a kiosk, home computer, tablet, cell phone, or other device.

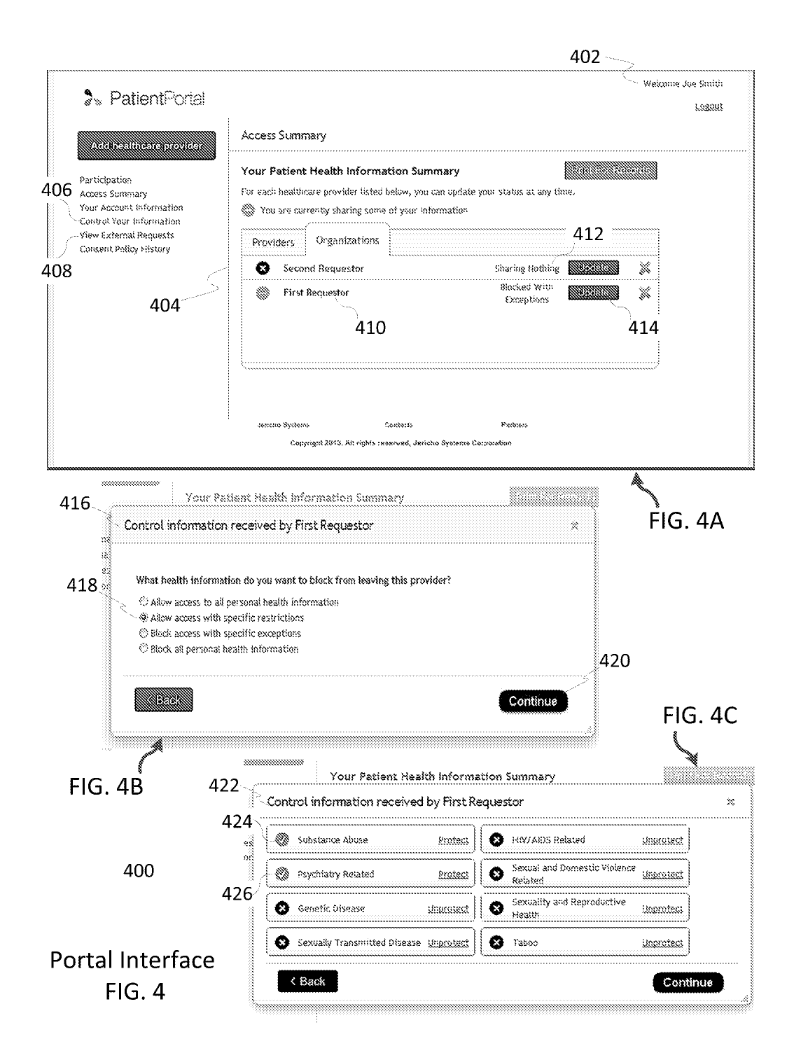

An example of a portal is shown in FIG. 4. FIG. 4A shows an example of a portal screen that allows the authenticated user, indicated at 402, to easily navigate to relevant information from the options in the left margin. For example, selecting the option “Access Summary” in the left margin displays the content shown in the main viewing area 404. Document custodians 410 are listed with the user's general consent posture 412 and buttons, for example, 414, allowing adjustment of the consent posture. Additional examples of portal function include changing PCD settings based on organization or named providers at 406, or viewing a list of requests for PCD and related release decisions at 408.

The process of changing the user's sharing directive can be assisted by, for example, a series of web pages, screens, or pop-ups that prompt the user through the workflow. The format of the saved user's sharing directive is not critical to the invention, as long as the information can be translated to a CDA-compliant PCD before its transmission to a document custodian. FIG. 4B shows an example of a pop-up window, pane or panel that assists the user in changing their sharing directive for a specific document custodian, indicated at 416. The user is allowed to adjust the overall consent posture by choosing, for example at 418, to allow access to PHI with specific exceptions for the specific custodian. The user progresses to the next step in the workflow using button 420. Another example is shown in FIG. 4C, where the user can control their sharing directive with a specific document custodian, indicated at 422. Labels that represent segmented data are displayed to the user. These settings can be changed, for example, if and when a user decides to change the directive. Users can select to protect or unprotect certain segments, such as “substance abuse” at 424 or “psychiatry related” at 426.

Once a requestor receives information about an individual, they can serve as a document custodian if that information is requested from them. In this example scenario, the first requestor becomes a document custodian of the individual's information and may send a release decision notification concerning the second requestor if the PCD repository can be found. The appropriate PCD repository might be identified, for example, using a broadcast or multicast request or by using an authoritative index, catalog, or service. Additionally, the location of the PCD repository appropriate to the information can be inserted into the requested information, which could be a standard document such as an HL7 CDA-compliant XML document. Table 2 provides an example of an XML code fragment that encodes a PCD repository location and is suitable for embedding in an HL7 CDA-compliant document prior to its release.

TABLE 2
XML encoding of the PCD Repository Location

```
<ClinicalDocument>
  ...
  <authorization>
    <templateId ... />
    <consent>
      <id root=”patient id root oid” extension=”232342\hat{ }1.2.3.4.5.5.66.6&
      ISO”/>
      <id root=”audit service reference oid” <extension=”atna01.
      mypcddomain.com/>
      <id root “XDS.b registry service oid” <extension=”atna01.
      mypcddomain.com/>
      <id root “XDS.b repository service oid” <extension=”atna01.
      mypcddomain.com/>
      <id root “XDS.b repository unique id oid” <extension=”
      1.2.3.4.5.56.6.6.77.7.7”/>
  ...
</ClinicalDocument>
```

The conditions surrounding the request for information from a document custodian depend on the architecture used in the request, which may be SOAP, REST or SMTP, as examples. Attributes associated with the request, the POU, security and privacy labels, identity of the requestor, requesting organization, the document custodian, and other information may all be important, depending on the granularity of the PCD. Access to medical records may require certain roles, hospital privileges, and/or licensure. The document custodian may retrieve and use external information, such as licensure from a trusted service, during the computerized evaluation of the information request. Sources of license information, for example, include state medical licensing entities, emergency care certification entities, and medical provider certification boards. Other examples include the exchange of insurance information without risking medical identity theft. The role of the requestor, as represented by the requesting organization, can be represented as described in ASTM E1986-09, “Standard Guide for Information Access Privileges to Health Information” Table 1 and 2, respectively. Those tables are hereby incorporated herein by reference.

Attributes related to health care in ASTM E1986-09 include roles held by data users. Examples include attributes grouped by categories such as nurse, pharmacist, and physician. These categories include subcategories, for example the category “physician” includes chiropractor, pathologist, and psychologist. These roles can be identified using object identifiers (OIDs) and can be mapped to SNOMED CT identifiers. ASTM E1633-08a, “Standard Specification for Coded Values Used in the Electronic Health Record,” provides additional examples. Coded values categories in ASTM E1633-08a, such as confidentiality status, have subcategories such as AIDS patient, HIV patient, and psychiatric patient that provide additional examples of attributes that could be exchanged in the information request.

Other attributes used in the field of medical information technology are widely known (see: U.S. National Library of Medicine, Source Vocabularies, 2012AA Release), including: SNOMED CT, DSM-IV, ICD-9, ICD-10, MeSH, LOINC, RxNorm, and X12.

The components and related infrastructure described above can be implemented in many ways. Users can communicate as described with any of several available web browsers, for example Firefox, Google Chrome, Internet Explorer, Opera, or Safari. Mobile devices may use operating systems, for example Android (Google Inc.), BlackBerry OS (Research In Motion Ltd.), iOS (Apple Inc.), Symbian OS (Nokia Inc.), Windows Phone (Microsoft Inc.), and Brew (Qualcomm). Communication may use the Hypertext Transfer Protocol (HTTP) and/or the Hypertext Transfer Protocol Secure (HTTPS) protocol. Secure communication channels may use protocols such as Transport Layer Security (TLS) and/or Secure Sockets Layer (SSL). Users may also use non-browser custom applications that support redirection over the HTTPS or the HTTP protocols. Additionally, alternative protocols to HTTP or HTTPS can be used, such as SPDY™ or Stream Control Transmission Protocol (SCTP). Requests for SOAP or RESTful services can be made from mobile devices, such as phone, laptops, personal digital assistants, or similar devices.

The exchange of information herein can be over computer networks using general-purpose computer servers and common operating systems. Examples of operating systems include: Unix, FreeBSD, Linux, Solaris, Novell NetWare, Mac OS X, Microsoft Windows, OS/2, TPF, and eComStation. SOAP, SMTP, RESTful services, web sites, authentication components, and authorization components discussed herein can be executed in application server environments, servlet containers, or custom system software. Many computing platforms are available, such as the Java Platform, Enterprise Edition (J2EE) that can support application server environments. Examples of application servers include: GlassFish (Oracle Corp.), WebSphere (IBM Corp.), JBoss (Red Hat), and Apache Geronimo (Apache Software Foundation). Many servlet containers are available, such as Jetty (Eclipse Foundation), Apache Tomcat (Apache Software Foundation), and Tiny Java Web Server (TJWS). Other computing platforms and applications are available and can be substituted.

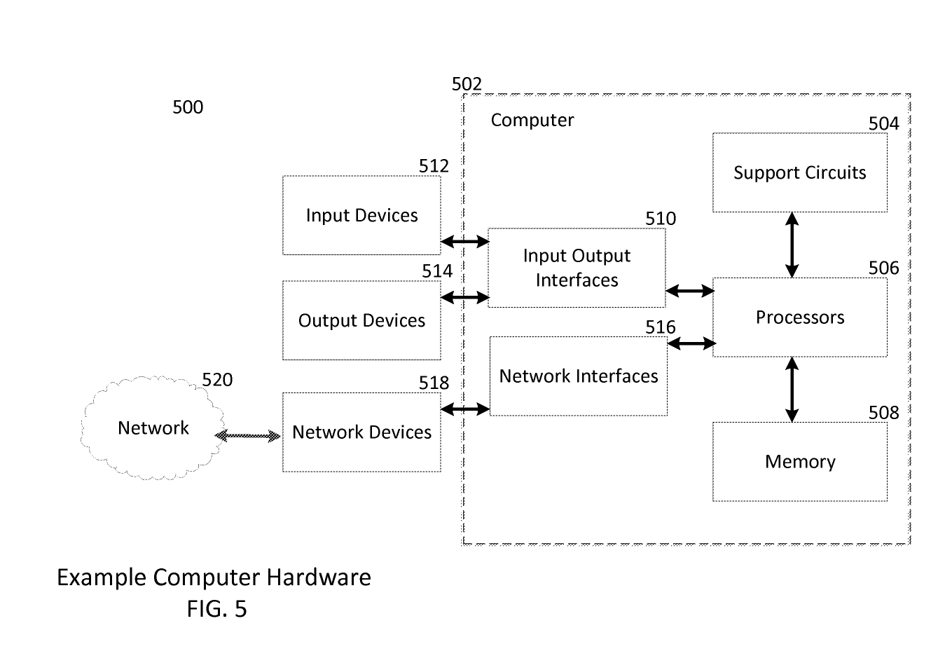

FIG. 5 shows an example representation of computer hardware 502 capable of supporting the general purpose computers referred to in this specification. Computers, or computing devices, may include one or more processors 506 with supporting circuits 504, operable to access memory 508. Input/Output (I/O) interfaces 510 permit communication with optional one or more input devices 512 and output devices 514 such as keyboards, monitors, smart card readers, fingerprint readers, USB drives, etc. Computer 502 communicates using network interfaces 516 and optional network devices 518 to one or more networks 520 using protocols, for example Transmission Control Protocol (TCP), Datagram Protocol (UDP), and SCTP. Components that may communicate with computer 502 through network 520 include information requestors, document custodians, PCD repositories, audit services and users, depending on the deployment of the computer. Other hardware architectures, such as special-purpose appliances or embedded systems, and additional features known to those skilled in the art are possible.

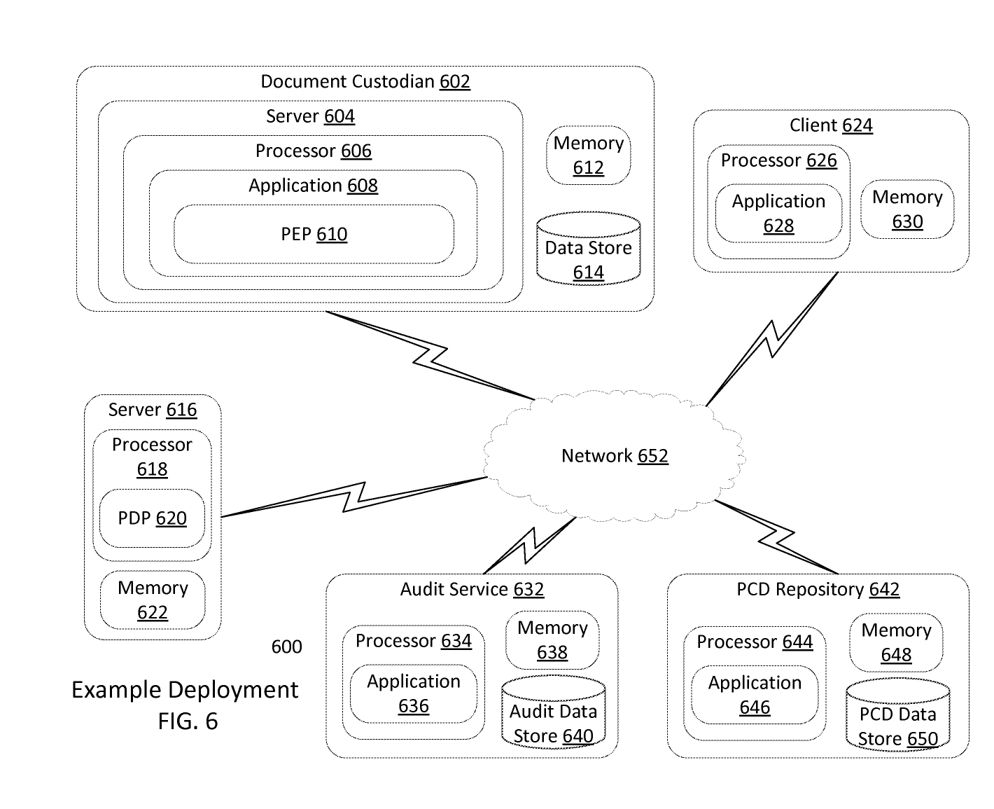

FIG. 6 shows an example deployment of components described in the specification. Document custodian 602 is comprised of server 604, which can be multiple servers, part of a server farm, virtual servers, or cloud services. Server 604 is depicted as having one or more processors 606 and available memory 612 operable to execute computer-executable instructions associated with application 608. Multiple processors can be used. Although a single memory 612 is shown for server 604, a wide variety of types and combinations of memory may be employed, such as random access memory (RAM), virtual memory, solid state memory, removable medium memory, rotating media memory, and other types of computer-readable media. Application 608 is depicted as having PEP 610, which is a software component integrated into, or called from, applications requiring a release decision, for example, from data store 614.

Server 616 comprises processor 618, which could be implemented with multiple processors. Processor 618 and available memory 622 are specifically configured and operable to execute computer-executable instructions associated with PDP 620. As depicted, server 616 communicates to PEP 610 through network 652. However, PDP 620 could instead be installed on server 604, in which case Network 652 need not be used to communicate between PEP 610 and PDP 620.

Audit service 632 comprises processor 634, which could be implemented with multiple processors. Processor 634 and available memory 638 are specifically configured and operable to execute computer-executable instructions associated with one or more applications 636 supporting the audit service functionality. Audit service 632 has access to audit data store 640, either locally, as shown, or remotely.

PCD repository 642 comprises processor 644 which could be implemented with multiple processors. Processor 644 and available memory 648 are specifically configured and operable to execute computer-executable instructions associated with one or more applications 646 supporting the PCD repository functionality. PCD repository 642 has access to PCD data store 650, either locally, as shown, or remotely.

Client 624 is depicted as having processor 626 and available memory 630 specifically configured and operable to execute computer-executable instructions associated with one or more applications 628. Multiple processors can be used. Additionally, although a single memory 630 is shown for the client 624, a wide variety of types and combinations of memory may be employed, such as random access memory (RAM), virtual memory, solid state memory, removable medium memory, rotating media memory, and other types of computer-readable media. Client 624 may be deployed on a kiosk, home computer, tablet, cell phone, or other compatible devices. Actors in the diagram, i.e., document custodian 602, server 616, client 624, audit service 632, and PCD repository 642, can be deployed to any combination of servers, including a single server. The concept of server includes multiple machines that act as a server, for example, in order to improve throughput or provide redundancy.

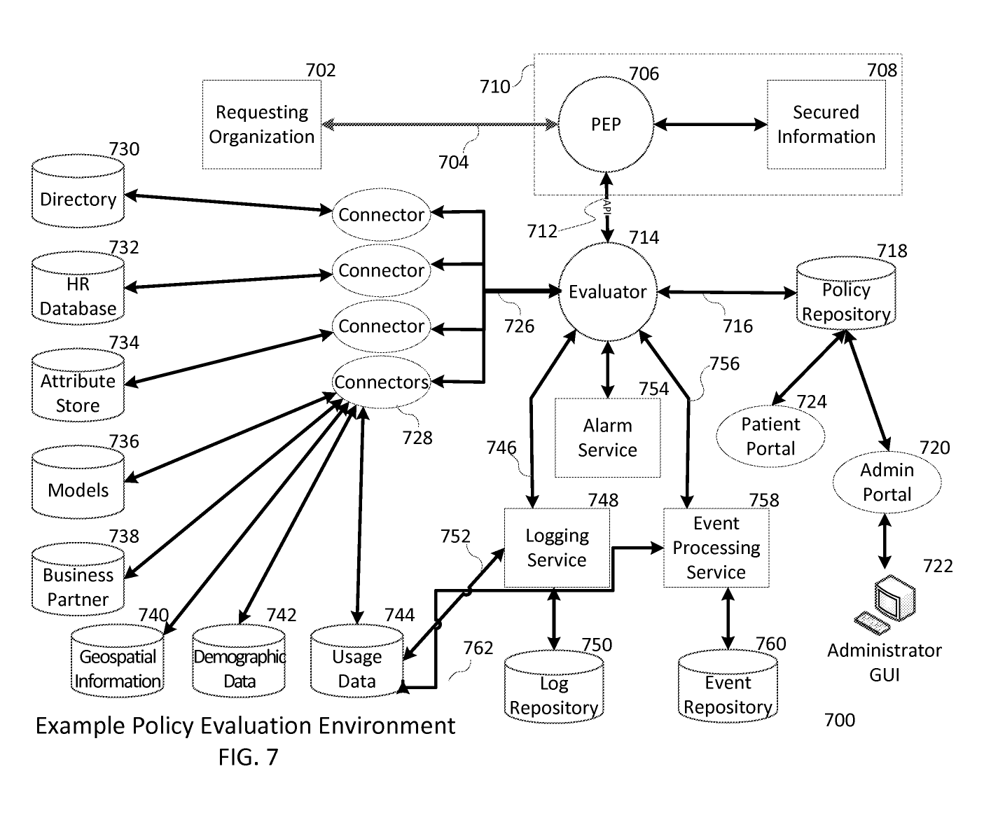

FIG. 7 shows an example policy evaluation environment operable to provide access control using a PEP. Requesting organization 702 makes a request over a communication channel 704 to document custodian 710. Communication channel 704 can use SOAP, REST, SNTP or some other protocols and can be secured using, for example, SSL or TLS. Access to secured information 708, for example PHI, requires authorization, at least in part by PEP 706, or equivalent. Both PEP 706 and secured information 708 are, typically, co-located within the document custodian's IT infrastructure. The remaining infrastructure can be remote or local to the document custodian. PEP 706 communicates at 712, typically over an application programmer interface (API), to evaluator 714, which can be a PDP. Evaluator 714 provides PEP 706 an access control decision that determines, in part, if the release of all or part of the requested information is authorized. The decision can be supported by policies encoding access decision rules stored at policy repository 718. Admin portal 720, optionally coupled with administrator GUI 722, allows, for example, organizational and/or jurisdictional policies to be created, reviewed, edited, stored, or revoked by authorized actors. Health care consumers' sharing directives can be encoded in policies and stored in policy repository 718 or in a separate repository, which could be shared between multiple organizations. Sharing directives can be created, reviewed, edited, stored, or revoked by consenters through various interfaces, such as patient portal 724.

Evaluator 714 uses appropriate policies, either cached or retrieved from policy repository 718, or equivalent, in combination with information passed with request 712, information known locally, for example, settings, embedded tables, etc., or information retrieved from patient portal 724. Information from patient portal 724, e.g. values selected by the consenter using patient portal 724, can be stored and accessed using connectors 726. Connectors 726 can use custom interfaces or standard protocols, for example, LDAP, SQL, HTTP, HTTPS, or CORBA. Examples of data stores can include directory 730, which can be an LDAP directory and can hold information about actors, such as persons, organizations, devices, etc. Information from other departments, for example human resources (HR) database 732 can also be used. Other attribute data sources 734 can hold additional attributes used in the evaluation of policies by evaluator 714, including system settings, such as whether an organization or region is currently approved to receive information they may request. Additional data sources can include modeling services, such as statistical or clinical support modeling data represented by models 736, or information from business partners, such as government or private payors, insurers, service agencies, public health agencies or other partner information 738. Additional data sources can also include geospatial information 740, which could include global positioning system (GPS) coordinates, internet protocol (IP) address to location mapping, zip code information, and wireless location provided by cell phone or tablet device, as examples. Additional data sources can also include demographic data 742, which could include information known about patients, consenters, clinicians, or other individuals, for examples. In addition to various nonlimiting examples of attribute data described herein useful to the evaluation of relevant access control policies, usage data 744 can also be retrieved, as described below.

Upon evaluation of the appropriate policies with the appropriate data, evaluator 714 returns the access control decision to PEP 706 and logs the decision and optionally some or all of the data used during evaluation at 746 to logging service 748. Information received by logging service 748 can be stored in log repository 750 and/or used to reflect usage data 744. Information encompassing the authorization to release information can also be sent from logging service 748, evaluator 714, PEP 706, or equivalent, to others, for example persons referenced in PHI, who could also be consenters using patient portal 724.

The example policy evaluation environment can also include alarm service 754 operable to receive alerts from evaluator 714. Alarm service 754 can provide alerts, for example over mobile devices, such as cell phones, personal device assistants (PDA), tablets, or other communication systems. Alerts can be triggered based on information passed with request 712, information known locally, for example, settings, embedded tables, etc., or information retrieved from patient portal 724, retrieved using connectors 728, or patterns or requests or system failures, for example.

Evaluator 714 can also send events at 756 to event processing service 758. Events can be triggered by encoded workflow associated with information passed with request 712, information known locally, for example, settings, embedded tables, etc., or information retrieved from patient portal 724 or patterns or requests or system failures, for example. Events processed by event processing service 758 can be recorded at event repository 760 and/or sent to usage data store 744. Event information 762 and/or logging information 752 can be used by evaluator 714, for example when usage information is encoded in a relevant access control policy. An example could be denial of request at 712 when a requesting organization has repeated request 704 within a set number of milliseconds, for example.

As described above, different deployments and implementations are possible in providing the functionality above, in keeping with the scope and spirit of the invention disclosed herein.

What is claimed is:

1. A method for providing consent information for the release of health information of an individual, comprising:
receiving, by a consent repository, a PCD request comprising at least one attribute value and at least one sensitivity label;
generating, by the repository, a patient consent directive from a consenter's sharing choices encoded in a composite patient consent directive, wherein the generating is based, at least in part, on the at least one attribute value and the at least one sensitivity label in the PCD request;
computing, by the repository, an authorization decision based, at least in part, on
1) the patient consent directive, and
2) the at least one attribute value and the at least one sensitivity label in the PCD request;
determining a set of sensitivity labels affecting the release of patient information, wherein the determination is based on the at least one sensitivity label in the PCD request;
sending, by the repository, a PCD response comprising the authorization decision and the determined set of sensitivity labels.

2. The method of claim 1, wherein the receiving of the PCD request by the consent repository PCD is over SOAP protocol.

3. The method of claim 1, wherein the receiving of the PCD request by the consent repository PCD is over REST protocol.

4. The method of claim 1, wherein the receiving of the PCD request by the consent repository PCD is over SMTP protocol.

5. The method of claim 1, wherein the patient consent directive is a subset of the information in the composite patient consent directive.

6. The method of claim 1, wherein the computing of the authorization decision uses a policy decision point.

7. The method of claim 1, wherein the PCD response is an HL7 CDA-compliant document.

8. The method of claim 7, wherein the PCD response directs a document custodian to redact the health information.

9. The method of claim 7, wherein the PCD response directs a document custodian to encrypt the health information.

10. A system, comprising:
a consent repository, running on one or more processors, operable to:
receive a PCD request comprising at least one attribute value and at least one sensitivity label;
generate, based on the at least one attribute value and the at least one sensitivity label in the PCD request, a patient consent directive from a consenter's sharing choices encoded in a composite patient consent directive;
compute an authorization decision based, at least in part, on
1) the patient consent directive, and
2) the at least one attribute value and the at least one sensitivity label in the PCD request;
determine, based on the at least one sensitivity label in the PCD request, a set of sensitivity labels affecting the release of patient information;
send a PCD response comprising the authorization decision and the set of sensitivity labels.

11. The system of claim 10, wherein the PCD request is a communication over SOAP protocol.

12. The system of claim 10, wherein the PCD request is a communication over REST protocol.

13. The system of claim 10, wherein the PCD request is a communication over SMTP protocol.

14. The system of claim 10, wherein the patient consent directive is a subset of the information in the composite patient consent directive.

15. The system of claim 10, further comprising a policy decision point.

16. The system of claim 10, wherein the PCD response is an HL7 CDA-compliant document.

17. The system of claim 16, wherein the PCD response encodes directions for redaction of health information.

18. The system of claim 16, wherein the PCD response encodes directions for encryption of health information.
